(19) United States
(12) Patent Application Publication
(10) Pub. No.: US 2011/0092161 A1
(43) Pub. Date: Apr. 21, 2011

(54) Wireless communication apparatus for monitoring proximity of a subject

(76) Inventor: Simon Dotan, Netanya (IL)

(21) Appl. No.: 12/923,931

(22) Filed: Oct. 14, 2010

Related U.S. Application Data
(60) Provisional application No. 61/252,831, filed on Oct. 19, 2009.

(51) Int. Cl. H04B 7/00; G08B 13/14

(52) U.S. Cl. 455/41.3; 340/572.1; 340/686.6

(57) ABSTRACT

A wireless communication apparatus for monitoring proximity of an object comprising a wireless communication USB dongle, such as a Bluetooth USB dongle, specifically configured and utilized as a remote tag 120 for monitoring the proximity of a target from a communication device 120. The remote tag is configured as a two-part USB device, the first part comprising a typical wireless communication USB dongle 125 (e.g. Bluetooth USB dongle) and a second part which connected to the first part. The second part 130 is connected in place of a computer to which the dongle is typically connected, and enables to utilize the wireless communication capabilities of the wireless communication USB dongle without the use of a computer or a similar communication device.

### FIELD OF THE INVENTION

This invention relates to monitoring the proximity to an object using wireless technology.

### BACKGROUND OF THE INVENTION

Prior art references considered to be relevant as a background to the invention are listed below and their contents are incorporated herein by reference. Acknowledgement of the references herein is not to be inferred as meaning that these are in any way relevant to the patentability of the invention disclosed herein.

US2009207013 discloses a portable proximity alarm apparatus comprising a Bluetooth system and an alarm monitors the presence of a portable electronic device equipped with a compatible transceiver within range and alarms when that device leaves its range. On detecting disconnection, the proximity alarm automatically tries to reconnect. A portable proximity alarm apparatus with an optional voice mode allows to additionally use the unit as a headset when an earpiece is folded. A portable proximity alarm apparatus with relay functionality allows using a Bluetooth headset and proximity alarm functions unobtrusively on most mobile phones.

US2009040048 discloses an improved system for tracking luggage and other such objects. The system features a transmitter tag for attachment to an object to be tracked and a receiver. When the tag comes within range of the receiver, the receiver provides notification to the user both visually and audibly. Audible notification can occur through the receiver's speaker, a wireless phone, a PDA, or an iPod or other portable music player. GPS capabilities

allow the tag to store and transmit its exact coordinates to assist in locating the tag. Airport and airline security personnel can access the tag data with a dedicated interface device.

U.S. Pat. No. 6,624,752 discloses a system and a method for detecting and identifying an object. More specifically the invention relates to a tag for attachment e.g. to luggage, the tag being adapted for transmission of an identifiable signal and a receiver for detecting and identifying the signal. The invention is concerned with use of the Internet and handheld terminals such as mobile phones in combination with Bluetooth™ or DECT technology for communicating information in relation to the object.

### GENERAL DESCRIPTION

According to a first aspect of the invention there is provided a system of monitoring proximity of a subject, the system comprising: a wireless enabled communication device; a remote tag for association with the subject, wherein the remote tag is configured as a two-part USB device, with first and second parts being detachably attachable to one another, the first part of the remote tag comprising a transmitter and a receiver unit configured for enabling wireless communication with the wireless enabled communication device, and the second part of the remote tag comprising at least a microprocessor and a power source, the first and second parts being configured such that the wireless communication of the tag is enabled upon attaching the first part to the second part.

According to some embodiments of the invention the microprocessor is configured and operable to transmit a return signal to the communication device, the return signal being indicative of a distance of the remote tag from the communication device, and the communication device is responsive to the return signal and configured and operable to analyze the return signal to determine whether a change occurred in an intensity of the return signal and activate an alert in case the change is greater than a predetermined threshold.

According to a second aspect of the invention there is provided an apparatus comprising: a female USB connector comprising a microprocessor, and a power source, and configured to be attached to male USB connector comprising a transmitter and a receiver unit configured for enabling wireless communication, wherein attachment of the female USB connector to the male USB connector provides a tag operative for wireless communication with a remote communication device.

According to a third aspect of the invention there is provided a method of monitoring proximity of a subject, the method comprising:
(a) utilizing a remote tag for transmitting a return signal to a wireless enabled communication device, wherein said remote tag is configured as a two-part USB device, with first and second parts being detachably attachable to one another, the first part of said remote tag comprising a transmitter and a receiver unit configured for enabling wireless communication with a wireless enabled communication device, and the second part of said remote tag comprising at least a microprocessor and a power source, said first and second parts being configured such that the wireless communication of the tag is enabled upon attaching said first part to said second part;
(b) utilizing said communication device for receiving said return signal, said signal being indicative of a distance of said remote tag from said communication device;
(c) determine whether a change occurred in an intensity of said signal; and
(d) activating an alert, in case said change is greater than a predefined threshold.

### BRIEF DESCRIPTION OF THE DRAWINGS

In order to understand the invention and to see how it may be carried out in practice, preferred embodiments will now be described, by way of non-limiting example only, with reference to the accompanying drawings, in which:

FIG. 1A is a schematic illustration of the technique of the invention for monitoring a subject (child);

FIG. 1B is a schematic illustration of a proximity monitoring system, in accordance with an embodiment of the invention;

FIG. 2 is a schematic illustration of a two-part remote tag 120, in accordance with an embodiment of the invention;

FIG. 3, is a flowchart exemplifying the principal operations carried out, in accordance with the invention; and

FIG. 4 is a flowchart illustrating another example of the operations carried out, in accordance with the invention.

### DETAILED DESCRIPTION OF EMBODIMENTS

As used herein, the phrase “for example,” “such as” and variants thereof describing exemplary implementations of the present invention are exemplary in nature and not limiting. Reference in the specification to “one embodiment”, “an embodiment”, “some embodiments”, “another embodiment”, “other embodiments”, “certain embodiment” or variations thereof means that a particular feature, structure or characteristic described in connection with the embodiment(s) is included in at least

one embodiment of the invention. Thus, the appearance of the phrase “one embodiment”, “an embodiment”, “some embodiments”, “another embodiment”, “other embodiments”, “certain embodiments” or variations thereof do not necessarily refer to the same embodiment(s).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. While the invention has been shown and described with respect to particular embodiments, it is not thus limited. Numerous modifications, changes and improvements within the scope of the invention will now occur to the reader.

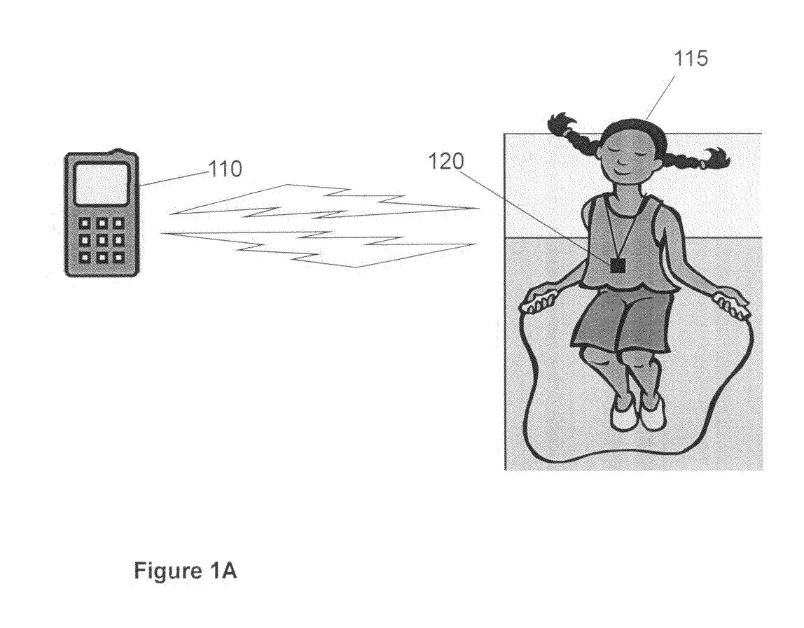

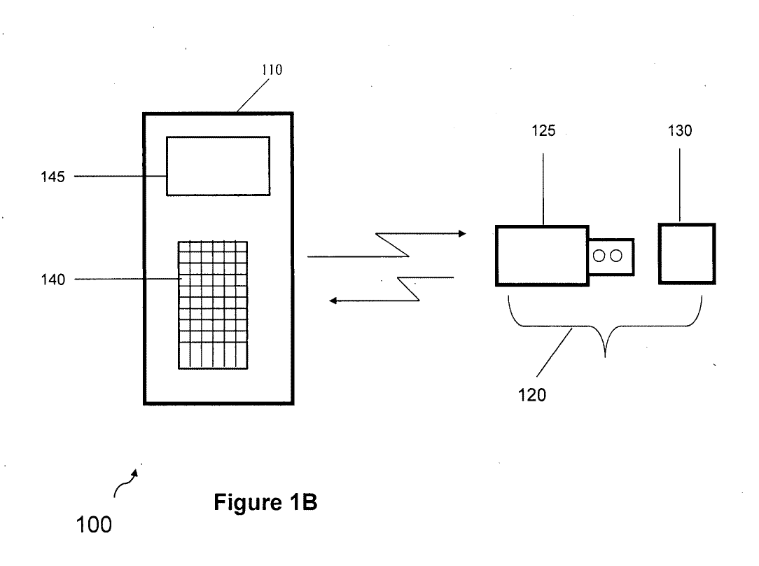

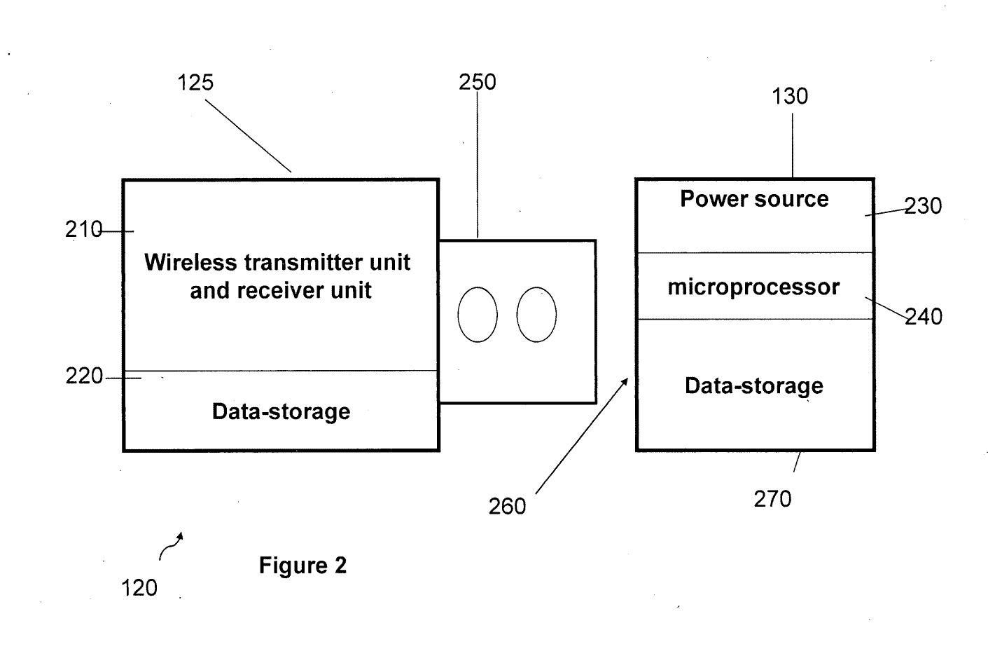

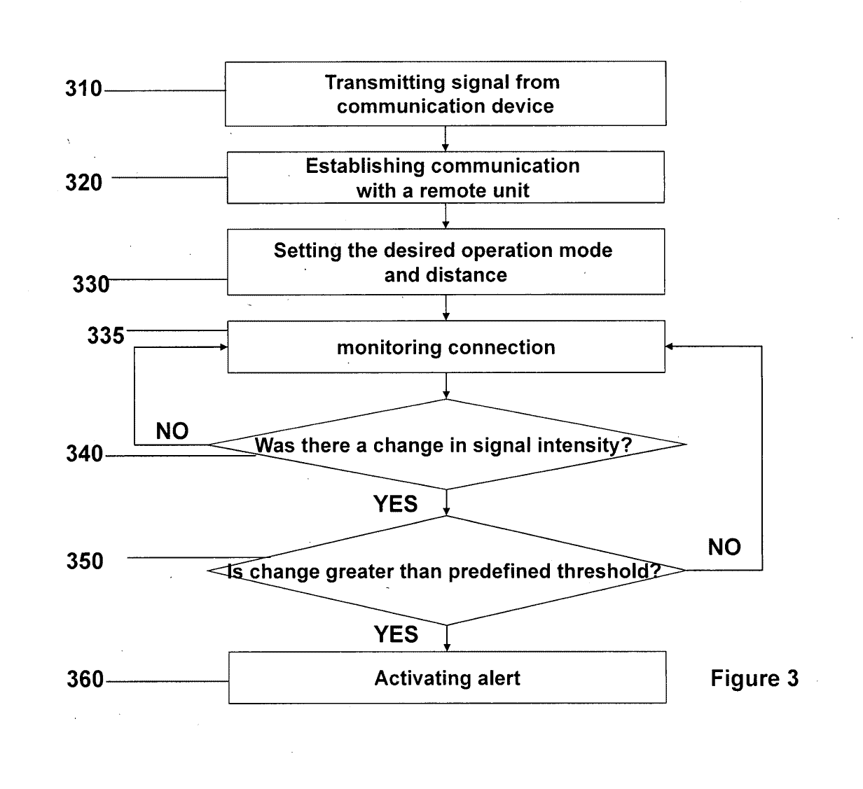

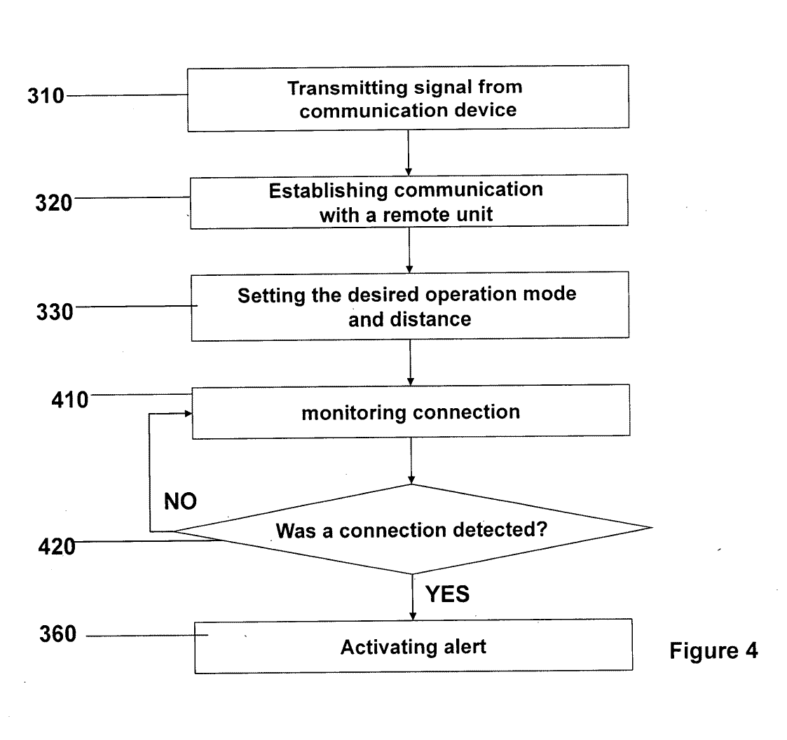

In embodiments of the invention, fewer, more and/or different stages than those shown in FIG. 3 and FIG. 4 may be executed. In embodiments of the invention one or more stages illustrated in FIG. 3 and FIG. 4 may be executed in a different order and/or one or more groups of stages may be executed simultaneously. FIG. 1A-1B and FIG. 2 illustrate a general schematic view of the system's architecture in accordance with an embodiment of the invention. Modules in these figures can be made up of any combination of software, hardware and/or firmware that performs the functions as defined and explained herein. In other embodiments of the invention, the system may comprise fewer, more, and/or different modules than those exemplified in the figures.

Unless defined otherwise, all technical and scientific terms used herein have the same meaning as commonly understood by one of ordinary skill in the art to which this invention belongs. Generally (although not necessarily), the nomenclature used herein described below are well known and commonly employed in the art. Unless described otherwise, conventional methods are used, such as those provided in the art and various general references.

FIG. 1A is a schematic illustration of the technique of the invention for monitoring a subject (child), in accordance with an embodiment of the present invention. FIG. 1A illustrated one possible application of the system and method of the present invention. The figure shows a playing child 115 who is wearing a remote tag 120 on her neck. The remote tag 120 communicates with a communication device 110 held by a responsible adult. The communication device 110 is configured and operable to monitor a distance to the tag, and thus enables a responsible adult to monitor the distance of the child from the adult. In the present example, the communication device 110 is a mobile phone device, however it should be understood that this may be any other electronic device capable of carrying out wireless communication with other devices.

According to one embodiment, the communication device 110 alerts the adult in case the child 115 moves out of a predefined range from the adult. The system and method of the present invention is not limited to monitoring the proximity of a child and may be utilized for other applications such as monitoring the proximity of subjects (e.g. anti-theft alert or anti-loss applications) where the remote tag is attached to a valuable subject and the user is indicated when the distance of the subject from the user is greater than a predefined threshold. The system may be utilized for the identification of specific objects, out of a plurality of objects or in a large area (e.g. identifying luggage in an airport) and any other application which requires monitoring the proximity of one object from another.

FIG. 1B is a schematic illustration of a proximity monitoring system, in accordance with an embodiment of the invention. The same reference numerals are used for identifying the components that are common in all the examples of the invention. In general, the system includes a communication device 110 configured to communicate with one or more remote tags 120. The communication device 110 is configured to transmit a wireless control signal which is received by the remote unit 120 and transmitted back (i.e. return signal) to be received at the communication device 110 in an ongoing loop.

The communication device 110 serves as a monitoring unit for monitoring the return signal and thereby monitor the distance between the communication device and the remote tag. The communication device 110 is configured to detect a change in the distance between the communication device 110 and the remote unit 120 and to alert the user accordingly, e.g. in case the change exceeds a predefined threshold. The case may be such that the user is notified when the distance between device 110 and remote unit 120 has increased and/or decreased.

According to another embodiment, the communication device 110 may be configured only to receive a signal from the remote tag 120 (without first transmitting a signal), i.e. the so-called passive mode, namely the distance is monitored by detection of the changes in the incoming signals transmitted from the remote tag 120 to the communication device 110, without first sending a signal from the communication device to the remote tag 120. In this case, the remote tag may be activated to start the transmission mode by an activation switch or other apparatus located on the remote tag, and/or by a remote activation signal transmitted from the communication device.

The communication between the communication device 110 and the remote tag(s) 120 may be established via any known version of wireless technology, preferably unlicensed wireless technology such as for example, Bluetooth or WiFi. It should be noted, that although in the following discussion the invention is described in connection to Bluetooth technology, this technology is only one example and should not be construed as limiting.

The communication device 110 is not limited to a mobile phone example and may be any device configured with adequate hardware and software for enabling communicating via a prescribed wireless communication protocol (e.g. Bluetooth). The communication device 110 is also configured with specifically programmed utility (hardware and/or software) for communicating with a remote tag. According to certain embodiments, the appropriate software may be downloaded to the communication device 110 from the communication network (the Internet) or otherwise obtained from any available storage medium or resource. The communication device 110 may be for example, a mobile (cell) phone, media player, portable computer, personal computer, PDA, etc. In some embodiments, the communication device 110 comprises a user interface 140 for enabling a user to interact with the system, set the device configuration, enter user's priorities, etc. According to other embodiments, the user interface and device configuration may be accessed by connecting the communication device 110 to a computer (e.g. via a USB connection) or some other device providing user interface facilities. The device 110 may also include a visual (screen) and/or audio data presentation utility 145, enabling a user to be notified about (view) received and other relevant information. The communication device also includes one or more types of indication (alarm) units for alerting the user, for example, sound, light, vibration, etc.

As for the remote tag 120, it should be noted that although in the following discussion the invention is exemplified as utilizing an USB connection, this type of connection is merely an example and should not be construed as limiting.

Preferably, the remote tag 120 which communicates with the communication device 110 is configured as a two-part wireless communication USB dongle (e.g. a Bluetooth USB dongle). USB dongle devices are known and typically comprise a data-storage encased in a shell having a male USB connector. A wireless communication USB dongle (e.g. Bluetooth USB dongle) used in the present invention is a USB dongle which includes hardware and software for enabling wireless communication and may be externally connected to a computer enabling wireless communication between the computer and other wireless enabled devices, of the same type. Typically, the activation of a wireless communication USB dongle is enabled via the connection of the dongle to a computer. The computer closes an electric circuit, supplies electric power and processing power to the Bluetooth dongle thereby enabling wireless communication.

According to certain embodiments of the invention, a wireless communication USB dongle, such as a Bluetooth USB dongle, is specifically configured and utilized as one (first) part 125 of a two-part remote tag 120 for monitoring the proximity of a target from a communication device 110, and is connectable to a second part 130 of the tag. The second part 130 (referred herein as a “cap”) is a computerized unit that enables utilizing the wireless communication capabilities of the wireless communication USB dongle without the use of a computer or a similar communication device. Thus, in accordance with the embodiments of the present invention, any wireless communication USB dongle can be easily, and with very low cost, transformed into a stand alone, wireless communication device, which can communicate with other wireless communication devices of the same type. In addition, the size of such two-part communication device is preferably maintained within the size of the original communication USB dongle. Furthermore, as USB dongles share the same structural standards, any cap of the present invention is compatible to any wireless communication USB dongle.

FIG. 2 is a schematic illustration of a two-part remote tag 120, in accordance with an embodiment of the invention. As mentioned above, the first part of the tag is a standard wireless communication USB dongle 125 (e.g. Bluetooth or WiFi) and the second part is a computer-cap 130. According to certain embodiments, the first part (also referred herein as “dongle”) 125 can be any standard wireless communication USB dongle, comprising at least the typical components of such a device. The dongle normally comprises an antenna transmitter and receiver unit 210 configured for enabling wireless communication. For example, a typical Bluetooth USB dongle, comprises an antenna and Bluetooth IC, including a transmitter and receiver unit, that enables Bluetooth wireless communication over the 2.4-2.4835 GHz radio frequency (RF) band, between a device to which it is connected (e.g. portable computer or a PC), and other nearby Bluetooth enabled devices. According to one embodiment, the transmitter and receiver may be integrated into one transceiver unit. The dongle 125 may also comprise a data-storage 220 for storing various data including data identifying each specific dongle 125 (e.g. the tag ID). According to some embodiments, the dongle 125 may include a user interface (not shown in figure) for enabling interaction of the user with the dongle 125.

According to certain embodiment, the cap 130 (or computer cap) includes a casing, having a cavity, structured as a female USB connector 260, and adapted to connect to a male USB connector 250 typically located at the end of the dongle 125. According to certain embodiments, the cap 130 comprises a microprocessor 240, a power source 230 and data-storage 270, components which are required to enable the operation of the dongle and to process the relevant data. When the dongle and the cap are attached to one another, an electric circuit is closed and the activation of the remote tag 120 is enabled. The power source 230 may be any type of suitable power source such as a battery, solar cell, a kinetic operating mechanism, etc. According to certain embodiments, data-storage 270 may include RAM and/or ROM memory units. Data-storage may be utilized for storing the appropriate software for operating the remote tag 120 including for example software required for operating a desired wireless communication protocol and/or including an Application Programming Interface (API). Data-storage may also store for example, information identifying the remote tag or the user thereof, information received by the dongle, operating preferences as set by the user, etc. In this connection it should be noted that as each cap 130 may by identified by a unique identification data (e.g. unique code) and as each cap 130 may be compatible with substantially any wireless communication USB dongle of the same type (e.g. Bluetooth or WiFi), each specific cap may be attached together with a plurality of different non-specific dongles to provide a proximity monitoring apparatus. According to certain embodiments, microprocessor 240 is configured, inter alia, for operating the relevant software and processing and authenticating incoming signal.

Turning now to FIG. 3, a flowchart is shown exemplifying the principal operations carried out in accordance with the invention. As described above, the remote unit 120, is a two-part USB dongle, where the two parts, the dongle 125 and the cap 130, are attached to one another during operation. Thus, to put the system into operation, the dongle 125 is attached to the cap 130. In stage 310, communication device 110 (e.g. cell phone) operates for transmitting an interrogating signal and searches for other compatible wireless enabled devices. Tags 120, located and operative in a range enabling reception, receive and identify the transmitted signal as that associated with the respective communication device 110. Thus, in stage 320, the system establishes a communication link or contact with one or more remote tags 120.

According to certain embodiments, in order to establish a connection between the communication device and the desired one or more remote tags, an authentication process is performed. The signal which is received by the remote tag is processed and the data identifying the incoming signal is used by the microprocessor 240 to authenticate the connection between the communication device and the remote unit. In some embodiments, an identification code, (e.g. sequence of numbers, letters or combination thereof) may be stored in the cap's 130 data-storage 270. According to some embodiments, the identification code is known to the user and is inputted to the communication device 110 before the operation of the system. Thus, the signal transmitted by the communication device comprise the identification code, which upon its reception can be compared by the microprocessor 240 to the identification code stored in the data-storage 270 in the cap 130 enabling the authentication of the connection. The remote device sends a return signal to the communication device. In another example, in case Bluetooth wireless communication is used, Bluetooth pairing may be performed during stage 320. Bluetooth pairing is a well known process to any person skilled in the art and therefore will not be discussed any further. Once the connection between the communication device and the remote unit is authenticated (sometimes known as a “trusted pair”), further authentication is typically not needed during the communication session between the two devices.

According to certain embodiments, the system allows the user to set the desired mode of operation. For example, the user may determine whether he wishes to be alerted when the distance between the communication device 110 and the remote unit 120 increases beyond a predefined distance. Alternatively or additionally, he may wish to be alerted when the distance between the communication device 110 and the remote unit 120 decreases beyond a predefined distance. The user may also wish to determine a change (being a decrease or increase) in the distance which would activate the alert. According to certain embodiments in stage 330 the user is allowed to set these (and possibly other) operating preferences. According to certain embodiments, setting the operating preferences is done via user interface 140.

In stage 335, the system enters monitoring mode. According to certain embodiments, in this mode the system monitors the connection between the communication device and the remote unit. During stage 335, the communication device and/or remote units may be in a low power mode, thereby keeping power consumption low. The communication device 110 transmits a first control signal to the remote unit 120 and in response the remote unit transmits a return signal. According to certain embodiments, based on the intensity of the return signal the distance between the communication device and remote signal can be determined. The signal transmitted by the communication device 110 may be a continuous signal, a periodic signal or it may be transmitted upon demand i.e. in response to a specific request by the user (e.g. by pressing a designated button). According to some embodiments, during stage 335, the remote unit 120 is configured to activate an alert in case it does not receive any signal from the communication device. To this end, the remote unit is equipped with one or more alerting devices (e.g. light, sound, etc.), which may be configured within the cap 130. Alternatively or additionally, the remote unit may send a specific signal to the communication device alerting it that no signal has been received, and the communication device may alert the user by one or more of the available alert means.

According to certain embodiments, in stage 340 the intensity of the return signal is determined. A change in the intensity may include any change which is detectable by the communication device 110 including for example an increase or a decrease in the signal's intensity. A change may include a complete interruption of the return signal which may indicate that the distance between the communication device and the remote unit is greater than the wireless transmitting and reception range of the system. If a change in the intensity of the return signal indicates a change in the distance the process continuous to stage 350, otherwise process returns to stage 335 and continuous to operate in monitoring mode. In stage 350 it is determined whether the change in the intensity of the signal indicates a change in distance which is greater than the predefined maximal allowed change (i.e. threshold), indicating a change in the distance which is greater than a predefined allowed distance. If the answer is yes, the system activates an alert for alarming the user about the detected change in distance 360. Otherwise the process returns to stage 335 and continues to operate in monitoring mode. According to certain embodiments, during stage 350 it is determined whether a change in the intensity of the return signal is greater than a predefined threshold, and before activating the alert, an additional stage takes place, during which the communication device attempts to reestablish the connection with the remote unit. Attempting to reestablish the connection may include transmitting a predefined number of signals or transmitting signals for a predefined time interval. In case the connection is reestablished the process returns to stage 335, otherwise an alert is activated 360. According to certain embodiments, in case the distance between the communication device and the remote unit returns to the allowed range the alarm is automatically turned off.

FIG. 4 is a flowchart illustrating another example of the operations carried out in accordance with the invention. In some cases, it is advantageous to operate the system of the present invention such that an alert is activated when a connection is reestablished between the communication device 110 and the remote tag 120 rather than when the communication intensity is decreased or communication is disconnected. In such cases in the initial state, there is no communication between the communication device 110 and the remote tag 120. For example, the remote tag may be attached to an object stored in an area or compartment which is outside of the reception range, thus communication between the communication device and the remote tag is disabled. Reestablishment of a connection indicates that the remote tag (and associated object) was moved from its original position. According to certain embodiments, stages 310 to 330 in FIG. 4 are similar to those described above with reference to FIG. 3. According to certain embodiments, the operation mode, which is determined in stage 330 comprises setting the system to activate the alarm once connection is reestablished. The communication device transmits the wireless communication signal and checks whether a return signal is detected 420. The signal may be transmitted periodically, continuously or on demand. The remote tag 120 may be in a low power sniff mode, configured to search for any incoming signal and sends a return signal in case a signal is indeed detected. According to certain embodiments, if a return signal indicating that the remote tag has been moved from its original location, is detected by the communication device 110, an alarm is activated. Otherwise, the communication device 120 continues to monitor for any incoming return signals.

According to certain embodiments, the remote tag 120 may be put, during stage 330, into “sleep mode”, where it is in a sniff low power mode searching or waiting for an activation signal from the communication device. Once an activation signal is transmitted from the communication device, the remote tag is “awakened” and becomes fully operative again, enabling to the system to monitor the distance between the communication device 110 and the remote tag 120. For example, consider a baggage being carried in a flight on an airplane. During the flight the communication device (e.g. a cell phone) must often be disabled. According to certain embodiments, in stage 330, the communication device 110 sends a signal to the remote tag 120, which puts the remote tag, is sleep mode. The remote tag is now ready to be activated upon demand by a remote signal. While the user is, waiting for his baggage at the baggage claim area in the airport he may operate the communication device 110 to transmit an activation signal to the remote tag 120. Once the remote tag is in the reception range of the communication device 110, it receives the activation signal and becomes fully operative. According to certain embodiments, the remote tag sends a return signal to the communication device 110, the signal being indicative of the distance between the communication device and the remote tag. According to certain embodiments, the remote tag may include an alarming device, such as for example a light (e.g. LED) or sound, which may be activated once the remote tag (and the associated baggage) is within a predetermined distance from the communication device 120.

According to certain embodiments, a single communication device may simultaneously monitor the distance from a plurality of remote tags. The communication device may be configured to selectively transmit a unique signal to each of the remote tags which are being monitored. The communication device may also be configured to receive and identify a plurality of return signals each originating from a different remote tag and thus to monitor the proximity of each remote tag individually, at substantially the same time. According to some embodiments, the communication device is equipped with an appropriate software and interface, allowing the user to monitor the information received in respect to each of the remote tags.

The present invention has been described with a certain degree of particularity, but those versed in the art will readily appreciate that various alterations and modifications may be carried out, without departing from the scope of the following Claims:

1. A system of monitoring proximity of a subject, the system comprising:
a wireless enabled communication device;
a remote tag for association with the subject,
wherein said remote tag is configured as a two-part USB device, with first and second parts being detachably attachable to one another, the first part of said remote tag comprising a transmitter and a receiver unit configured for enabling wireless communication with said wireless enabled communication device, and the second part of said remote tag comprising at least a microprocessor and a power source, said first and second parts being configured such that the wireless communication of the tag is enabled upon attaching said first part to said second part.

2. The system of claim 1, wherein said microprocessor is configured and operable to transmit a return signal to said communication device, said return signal being indicative of a distance of said remote tag from said communication device, and said communication device is responsive to said return signal and configured and operable to analyze the return signal to determine whether a change occurred in an intensity of said return signal and activate an alert in case said change is greater than a predetermined threshold.

3. The system of claim 2, wherein said remote tag is configured to receive a control signal from said communication device and transmit said return signal as a response to said control signal.

4. The system of any one of the preceding claims, wherein said second part of said remote tag comprises a data-storage configured for storing information identifying said second part of said remote tag.

5. The system of claim 4, wherein said data-storage is configured for storing software for operating a desired wireless communication protocol.

6. The system of any one of the preceding claims, wherein said communication device is a mobile phone.

7. The system of any one of the preceding claims, wherein said wireless communication is in accordance with Bluetooth standards, and said first part of said remote tag is a Bluetooth USB dongle.

8. The system of any one of the preceding claims, wherein said first part of said USB device has a male connective end, and said second part of said USB device has a female connecting end.

9. The system of any one of the preceding claims, wherein said communication device is configured with Bluetooth communication means.

10. The system of any one of claims 2 to 9, wherein said communication device is configured to activate said alert upon identifying one of the following conditions: (i) said change indicates that said intensity has increased by a predetermined threshold; (ii) said intensity has decreased by a predetermined threshold.

11. The system of any one of claims 2 to 10, wherein said alert is at least one of the following: sound, light, vibrations.

12. The system of any one of claims 3 to 11, wherein said second part of said tag comprises an alert utility and said microprocessor is configured to activate said alert in case no signal is received by said remote tag.

13. An apparatus comprising:
a female USB connector comprising a microprocessor, and a power source, and configured to be attached to male USB connector comprising a transmitter and a receiver unit configured for enabling wireless communication, wherein attachment of said female USB connector to said male USB connector provides a remote tag operative for wireless communication with a remote communication device.

14. The apparatus of claim 13, wherein said female USB connector comprises a data-storage configured for storing information identifying said tag.

15. The apparatus of claim 14 wherein said data-storage is configured to store software for operating a desired wireless communication protocol.

16. The apparatus of any one of claims 13 to 15 wherein said wireless communication is in accordance with Bluetooth standards and said male connector is a Bluetooth USB dongle.

17. The apparatus of any one of claims 13 to 16 wherein said female USB connector further comprises an alert utility and wherein said microprocessor is configured to activate said alert in case no wireless communication signal is detected by said remote tag.

18. A method of monitoring proximity of a subject, the method comprising:
(a) utilizing a remote tag for transmitting a return signal to a wireless enabled communication device, wherein said remote tag is configured as a two-part USB device, with first and second parts being detachably attachable to one another, the first part of said remote tag comprising a transmitter and a receiver unit configured for enabling wireless communication with a wireless enabled communication device, and the second part of said remote tag comprising at least a microprocessor and a power source, said first and second parts being configured such that the wireless communication of the tag is enabled upon attaching said first part to said second part;
(b) utilizing said communication device for receiving said return signal, said signal being indicative of a distance of said remote tag from said communication device;
(c) determine whether a change occurred in an intensity of said signal; and
(d) activating an alert, in case said change is greater than a predefined threshold.

19. The method of claim 18 further comprising:
utilizing said remote tag for receiving a first signal from said communication device and transmitting said return signal as a response to said first signal.

20. The method of any one of claims 18 to 19 further comprising:
utilizing information for identifying said remote tag, said information being stored in said second part of said remote tag.

21. The method of any one of claims 18 to 20 wherein said wireless communication is in accordance with Bluetooth standards and said first part of said remote tag is a Bluetooth USB dongle.
